(19) United States
(12) Patent Application Publication
(10) Pub. No.: US 2025/0017219 A1
(43) Pub. Date: Jan. 16, 2025

(54) AGRICULTURAL INPUT AND ASSOCIATED METHODS FOR PROTECTING AND FOR STIMULATING THE GROWTH OF A PLANT

(71) Applicant: MEDINBIO, WAVRE (BE)

(72) Inventor: Thierry PICAUD, Brussells (BE)

(21) Appl. No.: 18/697,903

(22) PCT Filed: Oct. 5, 2022
(86) PCT No.: PCT/EP2022/077747

§ 371 Date: Jul. 10, 2024

(30) Foreign Application Priority Data
Oct. 5, 2021 (FR) 2110547

(51) Int. Cl. A01N 63/30; A01N 25/02; A01N 63/22; A01P 21/00

(52) U.S. Cl. CPC A01N 63/30; A01N 25/02; A01N 63/22; A01P 21/00

(57) ABSTRACT

The invention relates to an agricultural input comprising at least two mycorrhizal fungi including at least one first mycorrhizal fungus belonging to the class of Glomeromycetes and at least one bacterium belonging to the species Bacillus amyloliquefaciens. The invention further relates to a method for stimulating growth and a method for protecting a plant comprising a step of treating a plant or a surface intended to receive the plant with an agricultural input according to the invention.

### TECHNICAL FIELD

The invention relates to the field of agriculture, and more particularly to biological control to protect plants and promote their growth. The invention relates to an agricultural input and a method for protecting and stimulating the growth of a plant.

### PRIOR ART

The domestication of plants by humans dates back nearly ten thousand years. For almost a century, agriculture has been industrialized and become more and more intensive. Indeed, agriculture, which is one of the keystones for feeding the world's population, estimated at around 7.6 billion and which will reach 9.8 billion by 2050, remains of capital importance. For example, according to the Food and Agriculture Organization of the United Nations, global demand for cereals will increase through 2030. Some experts predict modest growth, while others predict a whopping 50% increase. Thus, new solutions are regularly emerging, whether said solutions are related to improving production, for example by offering genetically modified young plants or chemical fertilizers, or related to crop protection, for example by developing pesticides (insecticides, fungicides, herbicides).

Although the use of pesticides has grown dramatically over the last century, it is now well known that pesticides have disadvantages that far outweigh, in the medium and long term, the advantages they confer. For example, certain pesticides can induce the appearance of pathologies for users handling them. The use of chemical fertilizers also causes pollution, particularly through the accumulation of nitrates and acid compounds, generating contamination of waterways and potentially leading to soil impoverishment.

Thus, reducing or even stopping the use of pesticides and fertilizers from the chemical industry is a major area of development, both on a health and environmental level.

Technical solutions aimed at eliminating or reducing the use of chemically synthesized fertilizers in agriculture have emerged. They are mainly based on the use of microorganisms allowing biocontrol of young plants or crops. Indeed, the use of certain microorganisms allows to limit infestation by certain species, such as nematodes, or contamination by certain pathogenic fungi while improving the development of young plants.

A first solution is described in patent application n° EP2050813 and proposes using different microorganisms present in the soil in order to improve the conditions for growth and development of plants while reducing the amount of harmful substances accumulated in the plants. For this purpose, this document mentions the use of a combination of at least two microorganisms selected from a mycorrhizal fungus, an actinomycete, a rhizosphere bacterium, a saprophytic fungus and a micromycete.

A second solution is described in patent application n° WO2020219432 and proposes a composition comprising different microorganisms and biostimulants, as well as a method for applying the composition. In this document, it is a question of overcoming chemical fertilizers and pesticides used to allow the protection, resistance and regrowth of the lawn. For this purpose, this document mentions the use of a Trichoderma harzianum, from the strain of Bacillus amyloliquefaciens NRRL B-67928 in combination with nutrient sources and possibly a mycorrhizal fungus, ascomycetes or else bacteria. Thus, such a combination allows the development of a lawn less likely to be contaminated by certain pathogens and having increased mechanical resistance by improving the development of its root network.

Currently, one of the major problems lies in the choice of microorganisms for treating young plants. Many of the microorganisms currently used have a beneficial effect when taken separately but lose this effect when combined. Indeed, the combination of several micro-organisms (bacteria, Trichoderma, fungi which are mychorizal or not) is often made complex by competition between these micro-organisms for the elements necessary for their growth, by different modes of action which have no synergy between them or else by a generation of compounds harmful to the development of other microorganisms. To still ensure the development of young plants, certain fertilizers are sometimes used in addition to microorganisms, however the use of fertilizers can also inhibit the growth of these microorganisms, making their use even more complex.

Thus, there is a need for new solutions, based on microorganisms, allowing effective biocontrol of a plant.

### Technical Problem

The invention has the purpose of overcoming the disadvantages of the prior art. In particular, the invention has the purpose of providing an agricultural input allowing to improve the development of a plant, in particular its growth, its resistance to biotic and abiotic stress, as well as an associated manufacturing method.

The invention further has the purpose of proposing a method for protecting and a method for stimulating the growth of a plant.

### SUMMARY OF THE INVENTION

The invention aims at overcoming these disadvantages.

The invention aims in particular at an agricultural input comprising at least two mycorrhizal fungi including at least one first mycorrhizal fungus belonging to the class of Glomeromycetes and at least one bacterium belonging to the species Bacillus amyloliquefaciens.

According to other optional characteristics of an agricultural input according to the invention, the latter may optionally include one or more of the following characteristics, alone or in combination:
the second mycorrhizal fungus is an endomycorrhizal fungus of the class of Glomeromycetes.
the first mycorrhizal fungus is selected from Rhizophagus irregularis and Glomus mosseae.
the first mycorrhizal fungus is Rhizophagus irregularis and the second mycorrhizal fungus is Glomus mosseae.
the ratio of the amount of spores of the first mycorrhizal fungus to the amount of spores of the second mycorrhizal fungus is comprised between 1/2 and 1/5, preferably between 1/3 and 1/4.
the ratio of the amount of spores of the first mycorrhizal fungus to the amount of spores of the bacteria of the species Bacillus amyloliquefaciens is comprised between 1/2*10⁵ and 1/5*10⁵, preferably between 1/3*10⁵ and 1/4*10⁵ and the ratio of the amount of spores of the second mycorrhizal fungus to the amount of spores of the bacteria of the species Bacillus amyloliquefaciens is comprised between 1/5*10⁵ and 1/2*10⁶, preferably between 1/1*10⁶ and 1/1.5*10⁶.

According to a second object, the invention relates to a method for manufacturing an agricultural input comprising a step of mixing at least two mycorrhizal fungi of which at least one first mycorrhizal fungus belongs to the class of Glomeromycetes and at least one bacterium belonging to the species Bacillus amyloliquefaciens.

According to a third object, the invention relates to a method for stimulating the growth of a plant including a step of treating a planted surface, a surface intended to receive the plant and/or the plant with at least two mycorrhizal fungi of which at least one first mycorrhizal fungus belongs to the class of Glomeromycetes and at least one bacterium belonging to the species Bacillus amyloliquefaciens, in which:
the step of treating the planted surface, or intended to receive the plant, is carried out by spraying or irrigation; or
the plant treatment step is carried out by coating.

According to a fourth object, the invention relates to a method for protecting a plant including a step of treating a planted surface, a surface intended to receive the plant and/or the plant with at least two mycorrhizal fungi of which at least one first mycorrhizal fungus is of the class of Glomeromycetes and at least one bacterium belonging to the species Bacillus amyloliquefaciens, in which:
the step of treating the planted surface, or intended to receive the plant, is carried out by spraying or irrigation; or
the plant treatment step is carried out by coating.

According to other optional characteristics of the stimulation method or the protection method according to the invention, the latter may optionally include one or more of the following characteristics, alone or in combination:
the treatment step includes at least one first application of a composition including the first mycorrhizal fungus of the Glomeromycetes class, at least a second application of a composition including the second mycorrhizal fungus, and at least a third application including at least the bacteria belonging to the species Bacillus amyloliquefaciens, the first, second and third applications being carried out concomitantly or sequentially.
the plant is selected from the group of families Vitaceae, Poaceae, Fabaceae, Solanaceae, Apiaceae, Alliaceae, Canabaceae or Rosaceae.

### DESCRIPTION OF EMBODIMENTS OF THE INVENTION

Other characteristics and advantages of the invention will be better understood upon reading the description which follows.

Below, a summary of the invention and the associated vocabulary are described, before presenting the disadvantages of the prior art, then finally showing in more detail how the invention overcomes them.

In the claims, the term “comprise” or “include” does not exclude, by definition, the presence of other elements or other steps than those mentioned.

“Treat” or “treatment”, in connection with the methods and the agricultural input according to the invention, means the fact of promoting the growth of a plant and preventing infestation or delaying or preventing the development of nematodes near treated plants.

The term “plant” must be understood in its broadest sense and can refer to any type of plant capable of allowing a symbiosis between a mycorrhizal fungus and the root system of the plant. More particularly, the plant can be in the form of a seed or in a more developed form in which the root system is fully or partially developed.

The term “spraying” relates to the action of projecting a composition in the form of drops, droplets or even an aerosol.

The expression “semi-liquid composition” corresponds to a half-liquid composition, that is to say in a physical state between the liquid state and the solid state. By way of non-limiting examples, a semi-liquid composition can be in the form of a cream or a gel, and have a viscosity ranging from 200 Pa s to 2000 Pa s (for Pascal second).

The term “mycorrhiza” corresponds to a symbiotic association between the roots of a plant and underground fungi called “mycorrhizal fungi”.

The expression “mycorrhizal fungus” within the meaning of the invention corresponds in particular to fungi of the ectomycorrhiza type, for which the symbiotic association of the mycorrhizal fungus with the roots of the plant is extracellular, or of the endomycorrhiza type, for which the symbiotic association of the mycorrhizal fungus with the plant roots is intracellular. Other types of mycorrhiza, such as ericoid, arbutoid, monotropoid, and orchid mycorrhiza, are also encompassed by the term “mycorrhizal fungus”.

When the term “between” is used to describe an interval of values, the limits are included.

As was mentioned, the current observation is that the use of pesticides and chemical synthetic fertilizers in agriculture, particularly to promote the growth and development of seeds, is predominant. Although the use of synthetic chemical fertilizers has serious consequences, the use of alternative solutions based on microorganisms remains complex to implement. Indeed, compositions including a single species of microorganisms often act on a single aspect of the development of a plant and compositions comprising several microorganisms often involve antagonisms.

Faced with this observation, the inventors have identified a particular combination of microorganisms, which when applied to the soil, or to a plant, allows to limit the development of nematodes while improving the development of the plant. This allows to avoid the use of chemical fertilizers or substances harmful to the soil.

In the remainder of the description, the different characteristics presented and/or claimed can be advantageously combined. Their presence in the description or in different dependent claims does not exclude this possibility.

Thus, according to a first aspect, the invention relates to an agricultural input comprising at least two mycorrhizal fungi and at least one bacterium.

Depending on the type of use desired, the agricultural input can advantageously be in the form of a liquid, solid composition, for example in powder, or else semi-liquid form. Preferably, the agricultural input is in liquid or semi-liquid form, that is to say that the mycorrhizal fungi, preferably their spores, are present in suspension in a liquid or semi-liquid medium. Furthermore, preferably, the agricultural input is in the form of a water-dispersible powder.

Furthermore, an agricultural input according to the invention comprises a first mycorrhizal fungus belonging to the class of Glomeromycetes.

Advantageously, the first mycorrhizal fungus is selected from the species Rhizophagus irregularis and Glomus mosseae. Preferably, the first mycorrhizal fungus belongs to the species Rhizophagus irregularis.

As mentioned above, an agricultural input according to the invention comprises a second mycorrhizal fungus. Advantageously, the second mycorrhizal fungus may be an endomycorrhizal fungus of the known type, preferably of the class of Glomeromycetes.

Alternatively, the second mycorrhizal fungus may be an ectomycorrhizal fungus of known type.

In order to further improve the development of the plant treated with an agricultural input according to the invention, the first mycorrhizal fungus may belong to the species Rhizophagus irregularis and the second mycorrhizal fungus may belong to the species Glomus mosseae.

In order to ensure optimal development of the plant treated with an agricultural input according to the invention, the ratio of the amount of spores of the first mycorrhizal fungus to the amount of spores of the second mycorrhizal fungus can be comprised between 1/2 and 1/5, preferably between 1/3 and 1/4.

Furthermore, to ensure optimal development of the plant treated with an agricultural input according to the invention, the first mycorrhizal fungus may be present at a concentration comprised between 4*10³ UPM/g and 8*10³ UPM/g, preferably between 5*10³ UPM/g and 7*10³ UPM/g, and the second mycorrhizal fungus may be present at a concentration comprised between 1*10³ UPM/g and 2*10³ UPM/g, preferably between 1.25*10³ UPM/g and 1.75*10³ UPM/g and vice versa.

As is well known to the person skilled in the art, a UPM represents the number of fungal cells capable of forming a symbiotic association with a root, that is to say a mycorrhiza.

Alternatively, when the agricultural input according to the invention is suspended in a suitable cultivation substrate, the first mycorrhizal fungus may be present at a concentration comprised between 55 UPM/L and 95 UPM/L, preferably between 65 UPM/L and 85 UPM/L, and the second mycorrhizal fungus may be present at a concentration comprised between 10 UPM/L and 30 UPM/L, preferably between 15 UPM/L and 25 UPM/L and vice versa.

Furthermore, when the agricultural input according to the invention is suspended in a suitable growing substrate, the Bacillus amyloliquefaciens species may be present at a concentration comprised between 1*109 CFU/L and 4*109 CFU/L, preferably between 2*109 CFU/L and 3*109 CFU/L.

As detailed previously, an agricultural input according to the invention comprises at least one bacterium, the bacteria preferably belonging to the species Bacillus amyloliquefaciens. Indeed, the inventors have demonstrated that when the agricultural input comprises a combination of the bacteria Bacillus amyloliquefaciens with at least two mycorrhizal fungi, at least one of which is from the class of Glomeromycetes, this greatly promotes the growth of the plant treated with such an agricultural input, and more particularly the mycorrhization rate, leaf weight and/or root weight. Plant growth is further enhanced when the first mycorrhizal fungus corresponds to Rhizophagus irregularis and the second mycorrhizal fungus corresponds to Glomus mosseae.

In order to ensure optimal development of the plant treated with an agricultural input according to the invention, the ratio of the amount of spores of the first mycorrhizal fungus to the amount of spores of the bacteria of the species Bacillus amyloliquefaciens can be comprised between 1/2*10⁵ and 1/5*10⁵, preferably between 1/3*10⁵ and 1/4*10⁵ and the ratio of the amount of spores of the second mycorrhizal fungus to the amount of spores of the bacteria of the species Bacillus amyloliquefaciens can be comprised between 1/5*10⁵ and 1/2*10⁶, preferably between 1/1*10⁶ and 1/1.5*10⁶.

In general, the Bacillus amyloliquefaciens species can be present, for example in solid form, at a concentration comprised between 1*10⁷ CFU/g and 1*10¹¹ CFU/g, preferably between 1*10⁸ CFU/g and 1*10¹⁰ CFU/g.

In order to promote the development of at least two mycorrhizal fungi and the bacteria Bacillus amyloliquefaciens, an agricultural input according to the invention may comprise a biofertilizing compound. Preferably, the biofertilizing compound may comprise a combination of prebiotics such as for example an aqueous extract of marine macroalgae, hydrolyzed fish meal proteins, humic acid and/or fulvic acid.

According to a second aspect, the invention relates to a method for manufacturing an agricultural input.

For this purpose, a manufacturing method in accordance with the invention comprises a step of mixing at least two mycorrhizal fungi such as those mentioned above and at least one bacterium belonging to the species Bacillus amyloliquefaciens.

The at least two mycorrhizal fungi and/or Bacillus amyloliquefaciens may be present respectively in the form of an aqueous emulsion, a concentrated suspension, a dispersible granule, a wettable powder, a powder of microcapsules/microparticles or a suspension of microcapsules/microparticles.

The at least two mycorrhizal and Bacillus amyloliquefaciens fungi can be mixed with a suitable substrate, for application by spraying, irrigation or coating, until the mixture is homogeneous.

According to a third aspect, the invention relates to a method for stimulating the growth of a plant.

For this purpose, the method comprises a step of treating a planted surface, that is to say a surface comprising a plant, a surface intended to receive the plant and/or the plant.

The treatment step corresponds to the application of at least two mycorrhizal fungi such as those mentioned above and at least one bacterium belonging to the species Bacillus amyloliquefaciens.

When it is the surface planted or intended to receive the plant which is treated, the treatment step may consist of an application by irrigation in the soil. However, the method according to the invention is also suitable for aerial treatment of crops in greenhouses or agricultural tunnels.

The treatment step may also consist of spraying the surface that is planted or intended to receive the plant. The treatment step can thus be carried out by any device allowing spreading (for example by spraying) on areas that are cultivated or to be cultivated.

Depending on the area to be treated, such a device may be in the form of a portable sprayer comprising a storage compartment for the composition to be sprayed, possibly an agitator positioned in the storage compartment in order to keep the substance moving and avoid the formation of deposition or sedimentation of strains or their spores, a pump, a distributor and a nozzle.

Depending on the size of the crops, the use of a mounted, semi-mounted or self-propelled sprayer towed or dragged by a motorized vehicle such as a tractor for example may be preferred.

Furthermore, the treatment step can be carried out by aerial spreading, such as by plane or helicopter or even via the use of drones, which are autonomous or not.

For greenhouse or tunnel crops, spreading by spraying can be carried out, for example, using a portable sprayer, as mentioned above, or even using projected jet spraying equipment.

Advantageously, in order to facilitate the spreading of mycorrhizal fungi and/or bacteria according to the method of the invention, the treatment step may comprise the application of a specially adapted vehicle. In this way, the composition can be more easily loaded into a device allowing spreading, its application is facilitated as well as the effectiveness of the treatment. The vehicle may correspond to a composition comprising water and/or any type of solvents or adjuvants of known type suitable for fungal suspensions, preferably of fungal and/or bacterial spores.

Furthermore, when the plant is in the form of a seed or has a fully or partially developed root system, the step of treating the plant can be carried out by coating. Indeed, it may be interesting to directly coat the root system of young plants, particularly seedlings, or of perennial plants as is the case for vines. Preferably, the plant treatment step may correspond to a film coating known to the person skilled in the art.

According to a fourth object, the invention relates to a method for protecting a plant.

Such a protection method includes a step of treating a planted surface, a surface intended to receive the plant and/or the plant such as that mentioned in connection with the growth stimulation method described previously.

In order to facilitate the application of at least two mycorrhizal fungi such as those mentioned above and at least one bacterium belonging to the species Bacillus amyloliquefaciens, particularly when the latter are used in different compositions, the step of treating a method for protecting and a method for stimulating the growth of a plant according to the invention may include at least one first application of a composition including the first mycorrhizal fungus of the class of Glomeromycetes, at least a second application of a composition including the second mycorrhizal fungus, and at least a third application including at least the bacteria belonging to the species Bacillus amyloliquefaciens.

Thus, the first, second and third applications can be carried out concomitantly or sequentially (that is to say separated in time), but in such a way that the at least two mycorrhizal fungi and the bacteria belonging to the species Bacillus amyloliquefaciens exert their effects jointly in the protection method and in the method for stimulating the growth of a plant according to the invention.

Advantageously, the methods according to the invention can be implemented on any type of crop, more particularly crops capable of allowing a symbiosis between a mycorrhizal fungus and the root system of the cultivated plant. The crops may in particular be field crops, or greenhouse crops, ornamental crops, or market gardening and preferably for the treatment of a plant selected from the group of families Vitaceae, Poaceae, Fabaceae, Solanaceae, Apiaceae, Alliaceae, Cannabaceae or Rosaceae.

The following examples illustrate the invention:

Example 1: demonstration of the rate of mycorrhization and root and leaf growth by the combination of Bacillus amyloliquefaciens, Glomus mosseae and Rizophagus irregularis applied to tomato seeds.

The mode of inoculum production differs depending on the family of fungi. Arbuscular mycorrhizal fungi are strict obligate symbionts, meaning they depend on the presence of a host plant to develop and multiply. Without the use of host plants it would be impossible to complete the life cycle of the mycorrhiza until the production of new propagules/spores.

### Materials and Methods

### Production of Mycorrhizal Fungal Spores

As part of the invention, the mycorrhizal fungi were multiplied on the roots of an entire host plant, cultivated in containers under controlled conditions. The methods for producing mycorrhizal fungal spores are well known to the person skilled in the art. In the context of the invention, the methods for producing spores of mycorrhizal fungi described by Tisserant, 2012 or else by Chabot, 1992 can be used indifferently.

However, other methods known to the person skilled in the art could be used for the production of mycorrhizal fungal spores.

### Agricultural Inputs Tested

TABLE 1

| Agricultural inputs | T1+ | T1− | MB | RI | TM | GB |
|---|---|---|---|---|---|---|
| Concentration of | 1.5*10⁵ | 0 | 6.5*10⁴ | 1.5*10⁵ | 6.1*10⁴ | 7.5169*10⁴ |
| mycorrhizal | UPM/m³ | | UPM/m³ | UPM/m³ | UPM/m³ | UPM/m³ for |
| fungi in solution | | | | | | Rizophagus |
| | | | | | | irregularis and |
| | | | | | | 2.0045*10⁴ |
| | | | | | | UPM/m³ for |
| | | | | | | Glomus mosseae |

T1+: potting soil + Rizophagus irregularis; T1−: cultivation substrate alone; MB: Rhizophagus irregularis + Pseudomonas fluorescens + Pseudomonas fulva; RI: Rizophagus irregularis; TM: Rhizophagus irregularis + Trichoderma harzianum + Trichodeerma atroviride; GB: Bacillus amyloliquefaciens (at 1.3*10⁹ CFU/L) + Glomus mosseae + Rizophagus irregularis.

### Application of Agricultural Inputs

The application of the test agricultural inputs was carried out by incorporating 10 grams of inoculum of each input into 30 liters of growing substrate, for each modality tested, then mixed for homogeneous distribution.

Concerning the control T1+, it comprises a mixture of a growing soil adapted to the type of plant of interest, in this case a soil for market gardening of known type, with the mycorrhizal fungus Rizophagus irregularis. In the same way as for the other inputs, 10 grams of inoculum of the agricultural input T1+ was incorporated into 30 liters of growing substrate.

Finally, concerning the agricultural input T1−, it consists only of the growing substrate. In this case the growing substrate comprises horticultural soil of a known type mixed with sand. The ratio of horticultural soil to sand is 2/1. The horticultural soil/sand mixture then underwent an autoclaving step.

The spores were diluted in a suitable liquid substrate to obtain agricultural inputs with an equivalent mycorrhizal fungus concentration.

### Cultivation of Plants

The tests were carried out in the laboratory, on AGORA HF1 abundant harvest tomato seeds (Vilmorin). The tomato seeds were sown in 32-well shelves (8*4 wells measuring 70*70*80 mm) and placed in controlled conditions at a temperature of approximately 25° C., with a brightness of 2000 lux and an applied photoperiod of 16/8.

Three random young plants were chosen in each modality tested, respectively at T+46 days, T+50 days and T+54 days after sowing the tomato seeds. They were then measured and weighed individually for the growth and weight indicators, then grouped for the mycorrhization rate indicator.

### Measuring the Mycorrhization Rate

The mycorrhization rate, representing the percentage of mycorrhizal colonization of arbuscules, was visually determined by the line intersection method (Ambler & Young, 1977). The root parts of each young plant were collected, colored then observed under a microscope (Katharina Klug, 2007). For each root segment, the presence of mycelium, arbuscules or vesicles was looked for.

Segments containing arbuscules were considered for the determination of the mycorrhization rate. The percentage of mycorrhizal root segments relative to the total amount of segments represents the total mycorrhization rate (Zougari Boutheina, 2012).

### Root Weight Measurement

The weight was recorded young plant by young plant for each modality by removing the root parts, which were then pre-washed and then weighed. The average value of root weight was then calculated for each modality.

### Root Length Measurement

The root length was recorded young plant by young plant for each modality on the root parts. The average value of root length was then calculated for each modality.

To determine the root length, the line intersection method (Newman, 1966) can for example be used. This method is based on the relationship which exists between the root length and the number of interceptions between the roots spread over a surface of defined area, and lines placed randomly in this area and of known length. The relationship between root length and number of interceptions is defined by the following equation:

n root length=π/4*number of interceptions*grid unit

However, other methods known to the person skilled in the art could be used for measuring root length.

### Results

Table 2 below shows the evolution of the mycorrhization rate over time observed for each of the test agricultural inputs used on tomato seeds.

TABLE 2

| | Evolution of the mycorrhization rate | | |
|---|---|---|---|
| Agricultural inputs | Day 46 | Day 50 | Day 54 |
| T1+ | 16% | 39% | 40% |
| (Positive control) | | | |
| T1− | 1% | 8% | 5% |
| (Negative control) | | | |
| MB | 24% | 40% | 25% |
| RI | 6% | 40% | 30% |
| TM | 42% | 50% | 30% |
| GB | 27% | 45% | 25% |

As expected, the positive control T1+ used in the test allows the formation of a symbiotic association between the mycorrhizal fungus and the plant.

It is observed that no symbiotic association is permitted by the use of the negative control T1− (substrate alone). Although a low rate of mycorrhization can be observed (between 1% and 8%), this can be explained by the fact that the substrate may have “contaminating” microorganisms at the start and responsible for the mycorrhization observed. The substrate alone therefore does not have any significant action promoting mycorrhization.

The mycorrhizal fungus Rhizophagus irregularis was also tested alone (RI agricultural input). A low mycorrhization rate is observable (6%) on day 46 while this increases very sharply in the days that follow, with a mycorrhization rate close to 40% on day 50 and around 30% on day 54. The agricultural input GB tested shows, just like the agricultural inputs MB and TM, a significant increase in the mycorrhization rate on day 46 of around 27% (agricultural input GB), that is to say more than 10% improvement compared to T1+ and more than 20% improvement compared to RI.

Although the mycorrhizal fungus Rhizophagus irregularis, taken alone, promotes mycorrhization, more particularly at T+50 days and at T+54 days, surprisingly, the combination of the fungi Rhizophagus irregularis, Glomus mosseae and the bacteria Bacillus amyloliquefaciens helps promote mycorrhization of the plant in the shorter term.

Table 3 below presents the evolution of root weight over time observed for each of the test agricultural inputs used on tomato seeds.

TABLE 3

| | Evolution of root weight | | |
|---|---|---|---|
| Agricultural inputs | Day 46 | Day 50 | Day 54 |
| T1+ | 0.04 g | 0.06 g | 0.06 g |
| (Positive control) | | | |
| T1− | 0.04 g | 0.03 g | 0.05 g |
| (Negative control) | | | |
| MB | 0.05 g | 0.05 g | 0.10 g |
| RI | 0.06 g | 0.05 g | 0.06 g |
| TM | 0.06 g | 0.06 g | 0.11 g |
| GB | 0.11 g | 0.10 g | 0.20 g |

Although the positive control T1+ used in the test helps promote mycorrhization of the plant (see table 2), it can be observed that it has no impact on the development of the root part of the plant. Indeed, the evolution of the root weight over time of plants treated with the agricultural input T1+ is substantially identical to that of plants treated with the agricultural input T1−.

Furthermore, it is possible to observe an increase in root weight at T+54 days for plants treated with agricultural inputs MB and TM whose root weight is respectively of the order of 0.10 g and 0.11 g, an increase of almost 100% compared to T1−. On the other hand, the use of Rhizophagus irregularis alone (agricultural input RI) does not demonstrate a significant increase in root weight over time.

The agricultural input GB shows that the association of the mycorrhizal fungus Rhizophagus irregularis with Glomus mosseae and the bacteria Bacillus amyloliquefaciens allows a significant increase in root weight at T+46 days (nearly 150% increase compared to T1−) as well as an even greater increase at T+54 days (nearly 300% increase compared to T1−).

Although the mycorrhizal fungus Rhizophagus irregularis, taken alone, does not promote the development of the root system of the plant, surprisingly, the combination of the fungi Rhizophagus irregularis, Glomus mosseae and the bacteria Bacillus amyloliquefaciens allows a strong increase in the root weight of the plant.

Table 4 below shows the evolution of root length over time observed for each of the test agricultural inputs used on tomato seeds.

TABLE 4

| | Evolution of root length | | |
|---|---|---|---|
| Agricultural inputs | Day 46 | Day 50 | Day 54 |
| T1+ | 73 mm | 81 mm | 88 mm |
| (Positive control) | | | |
| T1− | 80 mm | 62 mm | 87 mm |
| (Negative control) | | | |
| MB | 67 mm | 63 mm | 75 mm |
| RI | 110 mm | 88 mm | 87 mm |
| TM | 57 mm | 63 mm | 65 mm |
| GB | 92 mm | 73 mm | 123 mm |

As could be expected in view of the results related to the root weight (table 3), the positive control T1+ used in the test does not significantly promote the development of the root part, more particularly the root length, of the plant. Indeed, the evolution of the root length over time of plants treated with the agricultural input T1+ or T1− is essentially the same.

The mycorrhizal fungus Rhizophagus irregularis was also tested alone (agricultural input RI). Although the change in root length is significant at T+46 days and T+50 days (respectively almost 40% compared to T1−), it is identical to T1− at T+54 days. Unlike the agricultural inputs MB and TM, the application of which seems to induce a decrease in root length over time compared to T1−, the agricultural input GB tested shows a significant increase in root length compared to T1−. Indeed, although the increase in root length is less significant than with the agricultural input RI at T+46 days (around 15% compared to T1−) and at T+50 days (around 16% compared to T1−), it can be observed that the root length continues to increase significantly at T+54 days (more than 40% compared to T1−) unlike the treatment with the agricultural input RI.

Although the mycorrhizal fungus Rhizophagus irregularis, taken alone, promotes the development of the root length of the plant, surprisingly, the combination of the fungi Rhizophagus irregularis, Glomus mosseae and the bacteria Bacillus amyloliquefaciens allows, in addition to an increase in root weight, to also significantly increase the root length of the plant over time.

Example 2: demonstration of the improvement in the growth of different grape varieties of vine young plants grafted by the combination of Bacillus amyloliquefaciens, Glomus mosseae and Rizophagus irregularis.

### Materials and Methods

### Production of Mycorrhizal Fungal Spores

The mycorrhizal fungi were produced as presented in connection with Example 1.

### Agricultural Inputs Tested

TABLE 5

| Agricultural | | |
|---|---|---|
| inputs | T1− | GB |
| Concentration of | 0 | 6.000 * 10³ UPM/g |
| mycorrhizal | | for Rizophagus |
| fungi in film | | irregularis and |
| coating | | 1.500 * 10³ UPM/g |
| | | for Glomus |
| | | mosseae |

T1−: cultivation substrate alone;
GB: Bacillus amyloliquefaciens (at 1 * 10⁹ CFU/g) + Glomus mosseae + Rizophagus irregularis.

### Application of Agricultural Inputs

The application of the agricultural inputs tested was carried out by incorporating 10 grams of inoculum of each input into 990 g of a fixing co-agent, for each modality tested, then mixed for homogeneous distribution. The fixing co-agent is adapted to remain in contact with the roots once applied thereto, the fixing co-agent selected in the context of Example 2 is talc. 0.7 g of the talc/agricultural input mixture is then applied to the roots of the different planters.

The agricultural input T1− consists only of the fixing co-agent, in this case talc, 0.7 g of talc is applied to the roots of each planter.

The spores were diluted in a suitable liquid substrate to obtain agricultural inputs with an equivalent mycorrhizal fungus concentration.

### Cultivation of Plants

The tests were carried out in viticulture, with planters of different types of vines. Each planter corresponds to a grafted young plant. For each type of vine, 250 planters were cultivated on plots in dry areas, in order to induce water stress therein. A dry zone corresponds to an area where precipitation is counterbalanced by evaporation from plot surfaces and plant transpiration.

Fifty planters were chosen randomly, for each modality tested, one year after cultivation (at T+365 days). The number of leaves on the main branch as well as the length of the main branch were then determined.

### Counting the Number of Leaves on the Main Branch

The number of leaves on the main branch was determined by counting for each planter at a period of 365 days after their planting, the average number of leaves was then calculated for each modality.

### Measuring the Length of the Main Branch

The length of the main branch (better known as the shoot) was measured for each planter at a growth period, that is to say 365 days after planting, preferably carried out during the first quarter of the year. The average value of the length of the main branch was then calculated for each modality.

### Results

Table 6 below shows the evolution of the number of leaves on the main branch over time observed for each of the different planters tested, and for which the roots underwent a film-coating step with or without GB. The variation (denoted A) in the evolution of the number of leaves of the planters treated with GB is expressed as a percentage compared to the negative control (T1−).

TABLE 6

| | | Agricultural input | | |
|---|---|---|---|---|
| | | T1− | GB | |
| | Planter | Day 365 | Day 365 | Δ (variation) |
| Evolution | P1 | 13 | 16 | +23% |
| of the | P2 | 43 | 53 | +23% |
| number | P3 | 12 | 13 | +8% |
| of | P4 | 12 | 14 | +17% |
| leaves | P5 | 11 | 19 | +72% |
| | P6 | 12 | 16 | + 33% |

P1: SAUVIGNAC SO4 (Oppenheim selection number 4);
P2: CHARDONNAY 5BB;
P3: VIOGNIER 1103 PAULSEN;
P4: GRENACHE R110 (110 Richter);
P5: SEMILLON 3309C (Couderc 3309);
P6: GRENACHE R140 (Ruggeri 140).

The combination of the fungi Rhizophagus irregularis, Glomus mosseae and the bacteria Bacillus amyloliquefaciens allows to promote the foliar growth of planters to different degrees and on average by 30% if all the different types of planters are considered.

Table 7 below shows the evolution of the length of the main branch (cm) over time for each of the different planters tested and for which the roots underwent a film-coating step with or without GB. The variation (noted A) in the evolution of the length of the main branch of the planters treated with GB is expressed as a percentage compared to the negative control (T1−).

TABLE 7

| | | Agricultural input | | |
|---|---|---|---|---|
| | | T1− | GB | |
| | Planter | Day 365 | Day 365 | Δ (variation) |
| Evolution | P2 | 58.2 | 75.4 | +30% |
| of the | P3 | 42.0 | 47.1 | +12% |
| length | P4 | 40.2 | 47.4 | +18% |
| of the | P5 | 11.0 | 16.9 | +54% |
| main | P6 | 41.3 | 51.8 | +25% |
| branch | | | | |
| (cm) | | | | |

P2: CHARDONNAY 5BB;
P3: VIOGNIER 1103 PAULSEN;
P4: GRENACHE R110 (110 Richter);
P5: SEMILLON 3309C (Couderc 3309);
P6: GRENACHE R140 (Ruggeri 140).

The combination of the fungi Rhizophagus irregularis, Glomus mosseae and the bacteria Bacillus amyloliquefaciens also allows to promote the growth of the main branch of the planters to different degrees and on average by 28% if all the different types of planters are considered.

These examples show that the combination of at least two mycorrhizal fungi, at least one of which belongs to the class of Glomeromycetes, in particular Rhizophagus irregularis, Glomus mosseae fungi, with a bacterium belonging to the species Bacillus amyloliquefaciens allows effective biocontrol, in particular an improvement in the development of a plant, at different stages of its development, and its resistance to biotic and abiotic stress by promoting the growth of root parts while limiting the development of certain pathogenic fungi or harmful species, such as nematodes.

### BIBLIOGRAPHICAL REFERENCES

E. Tisserant and al. (2012). The transcriptome of the arbuscular mycorrhizal fungus Glomus intraradices (DAOM 197198) reveals functional tradeoffs in an obligate symbiont. New Phytologist.
Chabot, S and al. (1992). LIFE-CYCLE OF GLOMUS-INTRARADIX IN ROOT ORGAN-CULTURE. MYCOLOGIA, Volume: 84 Pages: 315-321.
Ambler, J. R., and Young, J. L (1977). Techniques for determining root length infected by vesicular-arbuscular mycorrhizae. Soil Science Society of America Journal.
Katharina Klug (2007). Systemic effects of mycorrhization on root and shoot physiology of Lycopersicon esculentum.
Zougari Boutheina (2012). Evaluation des champignons mycorhiziens arbusculaires (CMA) associés au palmier dattier (Phoenix dactylifera) dans la région du Djérid. 23^{rd} international forum of Biological Sciences and Biotechnology.
Newman El (1966). A method for estimating the total length of root in a sample. J Appl Ecol 3:139-145.

1. An agricultural input comprising at least two mycorrhizal fungi including at least one first mycorrhizal fungus belonging to the class of Glomeromycetes and at least one bacterium belonging to the species Bacillus amyloliquefaciens.

2. The agricultural input according to claim 1, wherein the second mycorrhizal fungus is an endomycorrhizal fungus of the class of Glomeromycetes.

3. The agricultural input according to claim 1, wherein the first mycorrhizal fungus is selected from Rhizophagus irregularis and Glomus mosseae.

4. The agricultural input according to claim 1, wherein the first mycorrhizal fungus is Rhizophagus irregularis and the second mycorrhizal fungus is Glomus mosseae.

5. The agricultural input according to claim 1, wherein a ratio of an amount of spores of the first mycorrhizal fungus to an amount of spores of the second mycorrhizal fungus is between ½ and ⅕.

6. The agricultural input according to claim 1, wherein a ratio of an amount of spores of the first mycorrhizal fungus to an amount of spores of the bacterium of the species Bacillus amyloliquefaciens is between ½*10⁵ and ⅕*10⁵, and a ratio of an amount of spores of the second mycorrhizal fungus to an amount of spores of the bacterium of the species Bacillus amyloliquefaciens is between ⅕*10⁵ and 1/2*10⁶, preferably between 1/1*10⁶ and 1/1.5*10⁶.

7. A method for manufacturing an agricultural input, comprising mixing at least two mycorrhizal fungi of which at least one first mycorrhizal fungus belongs to the class of Glomeromycetes, and at least one bacterium belonging to the species Bacillus amyloliquefaciens.

8. A method for stimulating the growth of a plant, comprising treating a planted surface, a surface intended to receive the plant and/or the plant with at least two mycorrhizal fungi of which at least one first mycorrhizal fungus belongs to the class of Glomeromycetes, and at least one bacterium belonging to the species Bacillus amyloliquefaciens, in which:
treating the planted surface, or the surface intended to receive the plant, is carried out by spraying or irrigation; or
treating the plant is carried out by coating.

9. A method for protecting a plant, comprising treating a planted surface, a surface intended to receive the plant and/or the plant with at least two mycorrhizal fungi of which at least one first mycorrhizal fungus is of the class of Glomeromycetes, and at least one bacterium belonging to the species Bacillus amyloliquefaciens, in which:
treating the planted surface, or the surface intended to receive the plant, is carried out by spraying or irrigation; or
treating the plant is carried out by coating.

10. The method according to claim 8, wherein treating the planted surface, the surface intended to receive the plant and/or the plant includes at least one first application of a composition including the first mycorrhizal fungus of the Glomeromycetes class, at least a second application of a composition including the second mycorrhizal fungus, and at least a third application including at least the bacterium belonging to the species Bacillus amyloliquefaciens, the first, second and third applications being carried out concomitantly or sequentially.

11. The method according to claim 8, wherein the plant is selected from plants within the group of families Vitaceae, Poaceae, Fabaceae, Solanaceae, Apiaceae, Alliaceae, Canabaceae or Rosaceae.

12. The agricultural input according to claim 5, said ration being between ⅓ and ¼.

13. The agricultural input according to claim 6, wherein the ratio of the amount of spores of the first mycorrhizal fungus to the amount of spores of the bacterium of the species Bacillus amyloliquefaciens is between ⅓*10⁵ and ¼*10⁵, and the ratio of the amount of spores of the second mycorrhizal fungus to the amount of spores of the bacterium of the species Bacillus amyloliquefaciens is between 1/1*10⁶ and 1/1.5*10⁶.

14. The method according to claim 9, wherein treating the planted surface, the surface intended to receive the plant and/or the plant includes at least one first application of a composition including the first mycorrhizal fungus of the Glomeromycetes class, at least a second application of a composition including the second mycorrhizal fungus, and at least a third application including at least the bacterium belonging to the species Bacillus amyloliquefaciens, the first, second and third applications being carried out concomitantly or sequentially.
